(19) United States
(12) Patent Application Publication
(10) Pub. No.: US 2019/0317610 A1
(43) Pub. Date: Oct. 17, 2019

(54) Keyboard with Ergonomically Positioned Shortcut Keys

(71) Applicant: Jack Lo, Redwood City, CA (US)

(72) Inventor: Jack Lo, Redwood City, CA (US)

(21) Appl. No.: 15/953,411

(22) Filed: Apr. 14, 2018

(51) Int. Cl. G06F 3/02

(52) U.S. Cl. CPC G06F 3/0219

(57) ABSTRACT

Copying and pasting information are among the most frequently used computer functions. In some operating systems, they are performed by pressing Ctrl+C and Ctrl+V respectively on a conventional keyboard with two fingers simultaneously. When such actions are repeated many times each day, they become tedious and tiring. The present keyboard provides one-touch Copy and Paste keys adjacent the Ctrl key where users are accustomed to pressing conventional key combinations for the copy and paste functions. Therefore the present Copy and Paste keys are relatively easy to learn and remember.

### BACKGROUND OF THE INVENTION

### Field of the Invention

This invention relates generally to computer input devices, and in particular to computer keyboards.

### Prior Art

A conventional and popular keyboard configuration 10 is shown in FIG. 1. It includes three main groups of keys: an alphanumeric section 12 with alphabetic keys and numeric keys, a navigation section 16 with keys that move the page or the cursor, and a numeric section 18 with number and calculation keys. A typical right-handed keyboard has alphanumeric section 12, navigation section 16 and numeric section 18 respectively arranged from left to right as shown.

A conventional alphanumeric section has a bottom row with a Ctrl key 20 at the left end and a spacebar 22 at an intermediate position. Some keyboards have three keys on the left of spacebar 22, and some have four keys, such as shown in FIG. 1. When there are four keys, they are typically Ctrl key 20, Fn key 24, Windows key 26 and Alt key 28. The Windows key is sometimes referred to as the Start key. The Fn key is commonly used in combination with the F keys such as F1-F12 to shift to keyboard shortcuts, such as interne browser, file explorer, volume control, etc.

Two of the most commonly used keyboard shortcuts are copy and paste. In the MICROSOFT® WINDOWS® operating system, copy is performed by pressing Ctrl key 20 and a C key 30 as shown in FIG. 2, and paste is performed by pressing Ctrl key 20 and a V key 32 as shown in FIG. 3. Performing the copy function requires spreading the fingers of the left hand slightly to press Ctrl with the last finger and C with the index finger. Performing the paste function requires spreading the fingers farther apart to press Ctrl and V.

The copy and paste functions are useful in many types of software and situations. They may be used many times a day by the average computer user. However, having to spread the fingers apart to press two keys at the same time is inconvenient. When such actions are repeated many times a day, they become very annoying.

Some keyboards provide one-touch copy and paste shortcut keys that perform these functions without having to press the Ctrl key, such as the keyboard disclosed in U.S. Pat. No. 6,712,535 to McLoone at al. The electronic technology of such shortcut keys is well known in the art. However, one-touch copy and paste keys on prior art keyboards are located too far from the Ctrl or C and V keys. Using them requires users to break the habit of reaching for the Ctrl or C and V keys. Therefore prior art one-touch copy and paste keys require a learning curve that many users are unwilling to overcome.

### BRIEF SUMMARY OF THE INVENTION

It is an object of the present invention to provide a keyboard with one-touch copy and paste keys that do not require pressing another key at the same time. It is another object of the invention to provide a keyboard with copy and paste keys relatively close to the conventional key combinations that users are accustomed to using for the copy and paste shortcuts. It is another object of the invention to provide one-touch copy and paste functions with existing physical keyboard layouts without adding extra physical keys, thereby making the manufacturing of the present keyboard simple and economical.

### BRIEF DESCRIPTION OF THE DRAWINGS

FIG. 1 is a prior art keyboard.

FIG. 2 is the prior art keyboard being operated by a left hand to perform the copy function.

FIG. 3 is the prior art keyboard being operated to perform the paste function.

FIG. 4 is a plan view of the present keyboard.

FIG. 5. is the present keyboard being operated by a left hand to perform copy and paste functions.

FIG. 6 is a second embodiment of the present keyboard.

FIG. 7. is a third embodiment of the present keyboard.

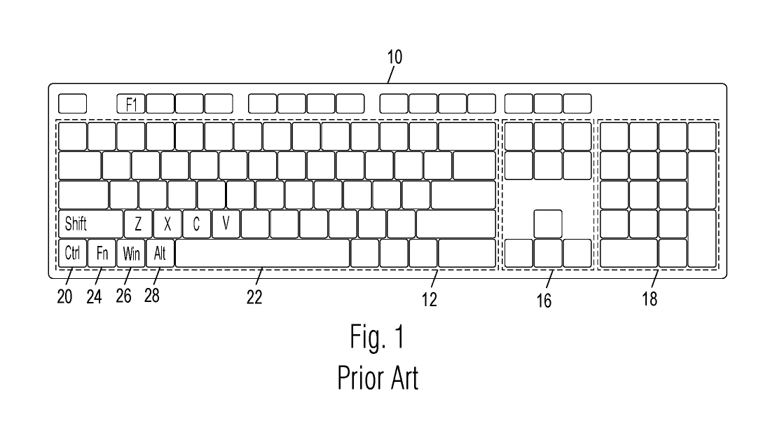

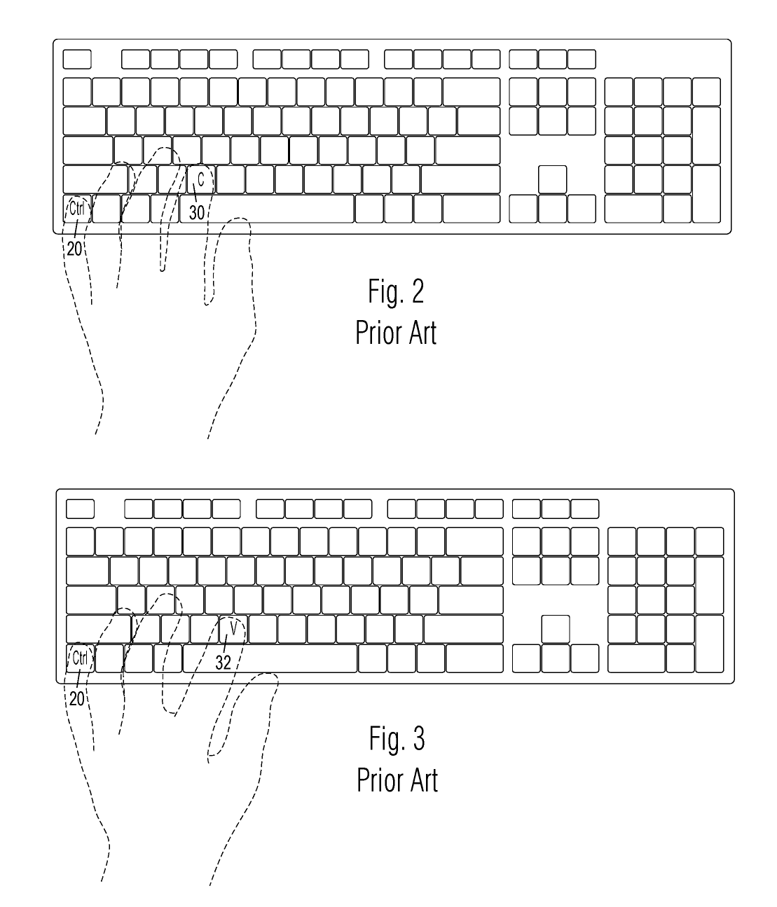

### DETAILED DESCRIPTION OF THE INVENTION

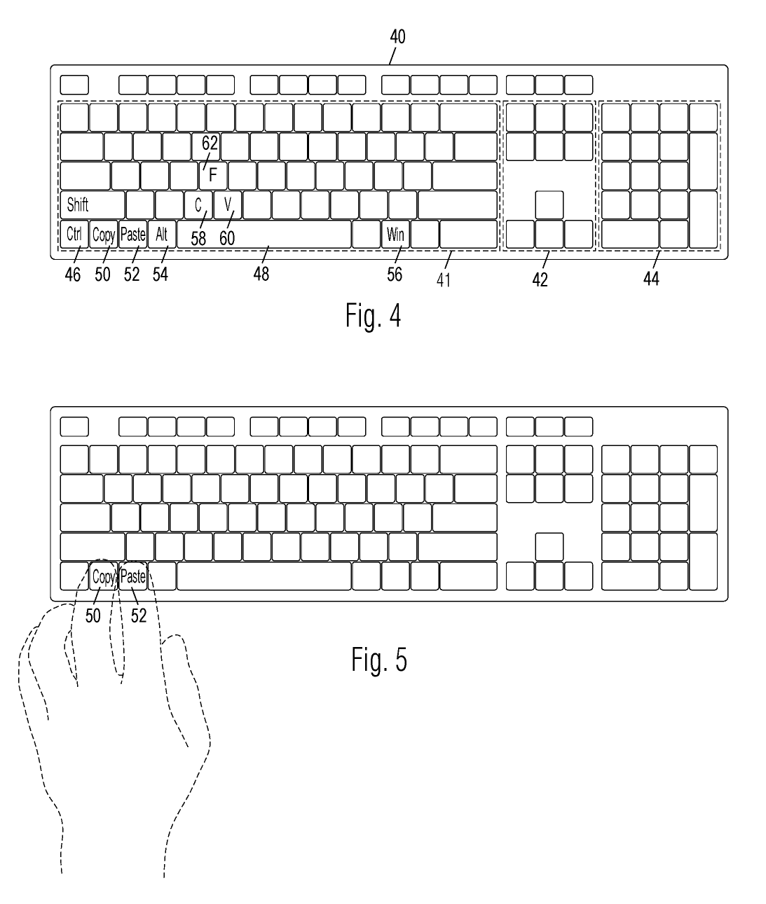

As shown in FIG. 4, the present invention is a keyboard 40 that includes an alphanumeric section 41. Other sections such as a navigation section 42 and a numeric section 44 may also be provided. A bottom row of alphanumeric section 41 includes a Ctrl key 46 at the left end and a spacebar 48 at an intermediate position. A one-touch Copy key 50 and a one-touch Paste key 52 occupy the positions that are otherwise the Fn and Windows keys on a conventional keyboard. An Alt key 54 and a Windows key 56 are positioned on the left and right of spacebar 48 respectively.

Copy key 50 is arranged to send the Ctrl+C keystroke, and Paste key 52 is arranged to send the Ctrl+V keystroke. The electronic and software operations of such functions are well known in the art. Keys 50 and 52 may be arranged to send other suitable keystrokes or signals for other operating systems to perform the copy and paste functions.

Copy key 50 and Paste key 52 are on the same row as Ctrl key 46, and are laterally positioned between Ctrl key 46 and a C key 58 and a V key 60. Therefore keys 50 and 52 are as close as possible to where users are accustomed to pressing the conventional key combinations Ctrl+C and Ctrl+V. Copy key 50 and Paste key 52 are also relatively near a F key 62, also known as a home key where the left index finger rests, so the user only needs to move the left hand a relatively short distance to press them. Therefore users may be more willing to use the present Copy and Paste keys 50 and 52 than prior art copy and paste keys that are farther away.

The copy and paste functions may be respectively performed by pressing Copy key 50 and Paste key 52 without having to press Ctrl key 46 or any other key at the same time. As shown in FIG. 5, one finger may press Copy key 50 and another finger may press Paste key 52. This makes copying and pasting multiple items in succession particularly convenient. For a right-handed user, the right hand may use the mouse to highlight items, and the left hand may conveniently remain on Copy key 50 and Paste key 52 to copy and paste items in quick succession.

By substituting the conventional Fn and Windows keys with Copy key 50 and Paste key 52, the copy and paste functions may be easily adapted to some existing keyboards at practically no additional cost. The conventional Fn function may be relocated to another key or eliminated.

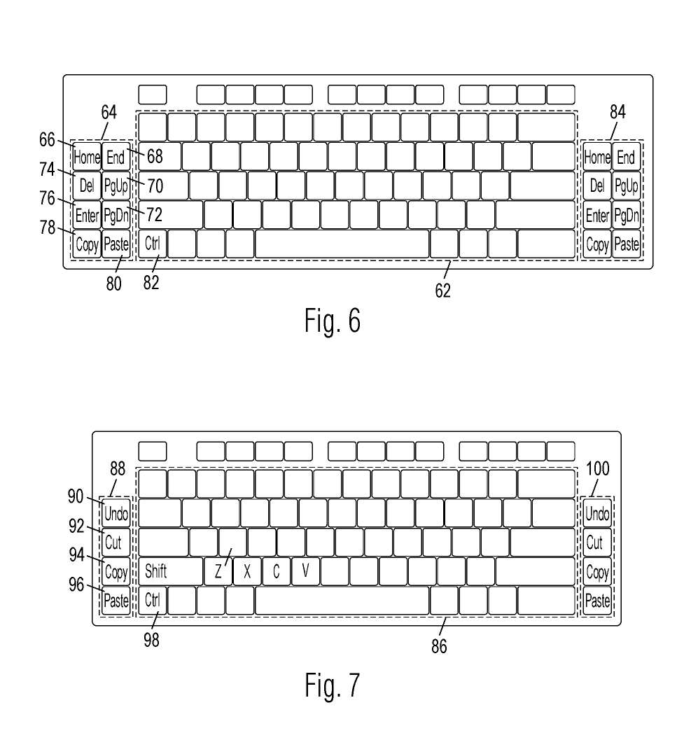

A second embodiment of the present keyboard shown in FIG. 6 includes a primary or alphanumeric section 62 and a left secondary section 64 on the left thereof. Secondary section 64 includes a Home key 66, an End key 68, a Page Up key 70, a Page Down key 72, a Delete key 74, an Enter key 76, a Copy key 78, and a Paste key 80. Copy key 78 and Paste key 80 are on the same row as a Ctrl key 82 in alphanumeric section 62. Paste key 80 is immediately adjacent Ctrl key 82. Secondary section 64 is duplicated on the right of alphanumeric section 62 as right secondary section 84. A right-handed user may have a mouse on the right of the keyboard and use the left secondary section 64 with their left hand, whereas a left-handed user may have a mouse on the left of the keyboard and use right secondary section 84 with their right hand.

A third embodiment of the present invention shown in FIG. 7 includes a primary or alphanumeric section 86 and a left secondary section 88 on the left thereof. Secondary section 88 includes an Undo key 90, a Cut key 92, a Copy key 94 and a Paste key 96 respectively arranged in a column from top to bottom. Paste key 96 is on the same row as a Ctrl key 98 in alphanumeric section 86, and is immediately adjacent Ctrl key 98. The order of keys 90, 92, 94, and 96 mimics the order of shortcuts on the keyboard, wherein Ctrl+Z is undo, Ctrl+X is cut, Ctrl+C is copy, and Ctrl+V is paste. Therefore users may find keys 90, 92, 94, and 96 relatively easy to learn and remember. Secondary section 88 is duplicated on the right of alphanumeric section 86 as right secondary section 100, thereby facilitating use of the keyboard by either the left hand or the right hand.

I claim:

1. A computer keyboard, comprising:
a spacebar with a left end and a right end;
a Ctrl key on the left of said spacebar along a common row with said spacebar; and
a Copy key and a Paste key wherein at least one of said Copy key and said Paste key is on said row and immediately adjacent said Ctrl key, whereby said Copy key and said Paste key are near positions where users are accustomed to pressing conventional key combinations for activating keyboard shortcuts for copying and pasting items.

2. The computer keyboard of claim 1 wherein said Copy key and said Paste key are both on said row aligned with said Ctrl key and on the left of said Ctrl key.

3. The computer keyboard of claim 1 wherein said Copy key and said Paste key are both on said row aligned with said Ctrl key and on the left of said Ctrl key, and above said Copy key and said Paste key are additional keys including a Home key, an End key, a Page Up key, a Page Down key and a Delete key arranged in two columns.

4. The computer keyboard of claim 1, further including a Windows key on said row on the right of said spacebar.

5. A computer keyboard, comprising:
a spacebar with a left end and a right end;
a Ctrl key on the left of said spacebar along a common row with said spacebar; and
a Copy key and a Paste key on said row between said Ctrl key and said spacebar, wherein said Copy key and said Paste key are near positions where users are accustomed to pressing conventional key combinations for activating keyboard shortcuts for copying and pasting items.

6. The computer keyboard of claim 5, further including a Windows key on said row on the right of said spacebar.

7. A computer keyboard, comprising:
a primary section comprising an alphanumeric section with a left side and a right side;
a spacebar in said alphanumeric section, said spacebar having a left end and a right end;
a Ctrl key on the left of said spacebar along a common row with said spacebar; and
a left secondary section on the left of said alphanumeric section including an Undo key, a Cut key, a Copy key and a Paste key arranged in a column respectively from top to bottom, wherein said Paste key is on said common row with and immediately adjacent said Ctrl key, wherein said Copy key and said Paste key are located near positions where users are accustomed to pressing conventional key combinations for activating keyboard shortcuts for copying and pasting items.

8. The computer keyboard of claim 7, further including a right secondary section on the right of said alphanumeric section with an duplicate key arrangement as said left secondary section, whereby said left secondary section is arranged for left hand operation and said right secondary section is arranged for right hand operation.
